(19) United States
(12) Patent Application Publication
(10) Pub. No.: US 2025/0245388 A1
(43) Pub. Date: Jul. 31, 2025

(54) CONTROL DEVICE, MEMORY DEVICE AND DATA STORAGE SYSTEM

(71) Applicant: SK hynix Inc., Icheon-si (KR)

(72) Inventors: Hyeong Ju NA, Icheon-si (KR); Dong Sop LEE, Icheon-si (KR)

(21) Appl. No.: 18/747,396

(22) Filed: Jun. 18, 2024

(30) Foreign Application Priority Data
Jan. 25, 2024 (KR) 10-2024-0011291

(51) Int. Cl. G06F 21/79; G06F 21/60

(52) U.S. Cl. CPC G06F 21/79; G06F 21/602

(57) ABSTRACT

An encryption operation on data stored in a memory device is performed using a timed key that changes depending on time to decrease the complexity of an encryption algorithm. Therefore, it is possible to reduce an area and power required for the encryption operation and to improve encryption performance. In addition, by controlling a period of generating the timed key according to a period of an operation of the memory device, an operation of encrypting or decrypting data using the timed key may be easily managed.

### CROSS-REFERENCE TO RELATED APPLICATION

The present application claims priority under 35 U.S.C. § 119 (a) to Korean Patent Application No. 10-2024-0011291 filed in the Korean Intellectual Property Office on Jan. 25, 2024, which is incorporated herein by reference in its entirety.

### BACKGROUND

### 1. Technical Field

Various embodiments of the disclosed technology generally relate to a control device, a memory device and a data storage system.

### 2. Related Art

A memory device may include a plurality of memory cells, which store data. The memory device may include a memory controller, which controls the operations of the plurality of memory cells. A memory controller may be implemented as a separate chip from the memory device.

The memory controller may control an operation of writing data to the plurality of memory cells or reading data written to the plurality of memory cells. If necessary, the memory controller may encrypt data stored in the plurality of memory cells. The size of the memory controller may increase when the memory controller provides an encryption function.

### SUMMARY

Various embodiments of the disclosed technology are directed to providing measures capable of performing encryption and decryption of data stored in a memory device while minimizing an increase in the size of a memory controller that controls the operation of the memory device.

In an embodiment, a data storage system may include: a memory device; and a control device configured to control an operation of the memory device, generate at least one timed key on the basis of a period of a scrub operation of the memory device, and perform, by using the at least one timed key, encryption on data to be written to the memory device or decryption on data written to the memory device.

In an embodiment, a control device may include: a random number generator configured to provide a random number for a period of a scrub operation of a memory device; a key generator configured to generate at least one timed key on the basis of the random number; and an encryption engine configured to encrypt data to be written to the memory device using the at least one timed key.

In an embodiment, a memory device may include: a memory cell array including a plurality of memory cells; and a memory controller configured to control an operation of the memory cell array, generate at least one timed key on the basis of a period of a scrub operation for the memory cell array, and perform, using the at least one timed key, encryption or decryption on data to be written to the memory cell array. According to the embodiments of the disclosed technology, it is possible to perform encryption and decryption of data stored in a memory device while minimizing an increase in the size of a module including the memory device.

### BRIEF DESCRIPTION OF THE DRAWINGS

FIG. 1 is a diagram illustrating a configuration of a computing system according to an embodiment of the disclosure.

FIG. 2 is a diagram illustrating a configuration of a data storage system according to an embodiment of the disclosure.

FIG. 3 is a diagram illustrating another configuration of a data storage system according to an embodiment of the disclosure.

FIG. 4 is a diagram illustrating a further configuration of a data storage system according to an embodiment of the disclosure.

FIG. 5 is a diagram illustrating a key generation method by a data storage system according to an embodiment of the disclosure.

FIGS. 6 to 8 are diagrams illustrating methods in which a data storage system processes data using a key according to an embodiment of the disclosure.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings. Further, in the following description of examples or embodiments of the present disclosure, detailed descriptions of well-known functions and components incorporated herein will be omitted when it is determined that the description may make the subject matter in some embodiments of the present disclosure more unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the present disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, or manufacturing methods, these terms may be used to describe non-consecutive or non-sequential processes or operations unless the term “directly” or “immediately” is used together.

In addition, when any dimensions, relative sizes etc. are mentioned, it should be considered that numerical values for elements or features, or corresponding information (e.g., level, range, etc.) include a tolerance or error margin that may be caused by various factors (e.g., process factors, internal or external impact, noise, etc.) even when a relevant description is not specified. Further, the term “may” fully encompasses all the meanings of the term “can”.

Hereinafter, various embodiments of the present disclosure will be described in detail with reference to accompanying drawings.

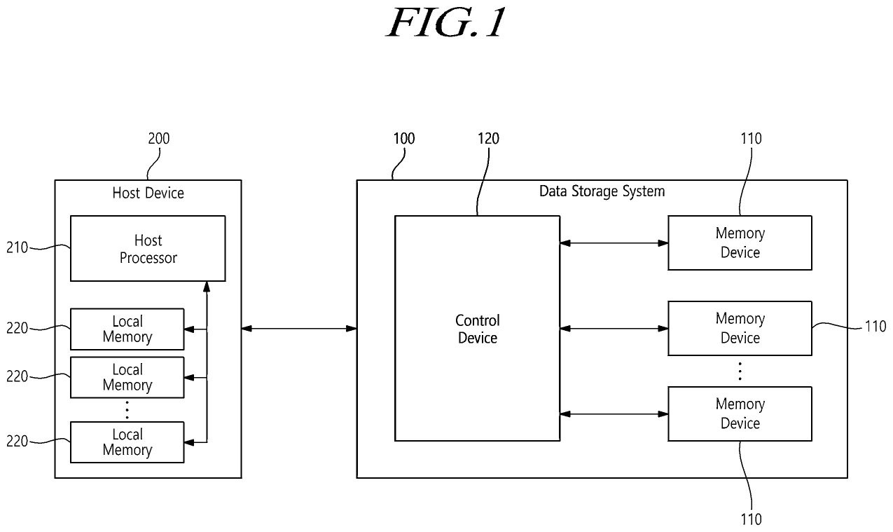

FIG. 1 is a diagram illustrating a configuration of a computing system according to an embodiment of the disclosure.

Referring to FIG. 1, a computing system may include a data storage system 100 and a host device 200.

The host device 200 may include a host processor 210 and at least one local memory 220.

For example, the host device 200 may be a computer, an ultra mobile PC (UMPC), a workstation, a personal digital assistant (PDA), a tablet, a mobile phone, a smartphone, an e-book, a portable multimedia player (PMP), a portable game player, a navigation device, a black box, a digital camera, a digital multimedia broadcasting (DMB) player, a smart television, a digital audio recorder, a digital audio player, a digital picture recorder, a digital picture player, a digital video recorder, a digital video player, a storage configuring a data center, one of various electronic devices configuring a home network, one of various electronic devices configuring a telematics network, an RFID (radio frequency identification) device, a mobility device (e.g., a vehicle, a robot or a drone) capable of driving under human control or autonomous driving, or the like. Alternatively, the host device 200 may be a virtual/augmented reality device that provides a 2D or 3D virtual reality image or augmented reality image. In addition, the host device 200 may be any one of various electronic devices, each of which requires a data storage system 100 capable of storing data.

The host device 200 may include at least one operating system. The operating system may manage and control overall functions and operations of the host device 200. The operating system may control the interoperation between the host device 200 and the data storage system 100. The operating system may be classified into a general operating system and a mobile operating system depending on the mobility of the host device 200.

The host processor 210 of the host device 200 may perform data processing using the local memory 220 included in the host device 200. The local memory 220 may be, for example, a volatile memory such as a DRAM, an SDRAM, a DDR SDRAM and an LPDDR SDRAM, but embodiments of the disclosed technology are not limited thereto.

The host device 200 performs data processing using the local memory 220, and may also perform data processing using the data storage system 100 located outside the host device 200. For example, at least two host devices 200 may perform data processing by being allocated memory areas necessary for data processing from the data storage system 100. At least two data storage systems 100 may be used by the at least two host devices 200. Each of the at least two host devices 200 may occupy and use a partial memory area of the data storage system 100, or may share and use the corresponding memory area with another host device 200.

The host device 200 may perform communication with the data storage system 100 through various interfaces.

For example, the host device 200 may communicate with the data storage system 100 through a Compute Express Link (CXL) interface. The host device 200 may be set as a CXL root port, and the data storage system 100 may be set as a CXL end point. Since the host device 200 communicates with the data storage system 100 through the CXL interface, a low-latency high-bandwidth access environment may be implemented in a high capacity structure that communicates with the data storage system 100.

In other embodiments, the host device 200 may communicate with the data storage system 100 through an interface other than a CXL interface.
the host device 200 and the data storage system 100 may communicate through at least one from among various interface protocols such as a USB (universal serial bus) protocol, an MMC (multimedia card) protocol, a PCI (peripheral component interconnection) protocol, a PCI-E (PCI-express) protocol, an ATA (advanced technology attachment) protocol, a serial-ATA protocol, a parallel-ATA protocol, an SCSI (small computer system interface) protocol, an ESDI (enhanced small disk interface) protocol and an IDE (integrated drive electronics) protocol, as non-limiting examples.

As such, the type and number of host devices 200 that perform communication with the data storage system 100, and the communication interface between the data storage system 100 and the host device 200 may vary.

The data storage system 100 may include at least one memory device 110. The data storage system 100 may include a control device 120, which controls the operation of the at least one memory device 110.

The memory device 110 may be, for example, a volatile memory such as a DRAM, an SDRAM, a DDR SDRAM and an LPDDR SDRAM, but embodiments of the disclosed technology are not limited thereto. The memory device 110 may be a nonvolatile memory. Some memory devices 110 included in the data storage system 100 may be volatile memories, while other memory devices 110 may be nonvolatile memories.

The control device 120 may control the operation of the memory device 110. The control device 120 may control the operation of the memory device 110 according to a request from the host device 200. The control device 120 may control the operation of the memory device 110 regardless or in the absence of an external request.

For example, the control device 120 may control an operation of writing data to the memory device 110 or reading data already written to the memory device 110, according to a command inputted from the outside. The control device 120 may control an operation (e.g., refresh, patrol scrub, etc.) for preserving data written to the memory device 110, depending on the type of the memory device 110. The control device 120 may control an operation of erasing data written to the memory device 110, depending on the type of the memory device 110.

The control device 120 may perform an encryption or decryption operation on data in the process of writing data to the memory device 110 or reading data from the memory device 110. Since encrypted data is stored in the memory device 110, the security of the memory device 110 may be improved.

In addition, the control device 120 in embodiments of the disclosure may change and use a key for encryption, depending on a time, to decrease the complexity of an algorithm which performs encryption and reduce the size of the control device 120 which provides the encryption function.

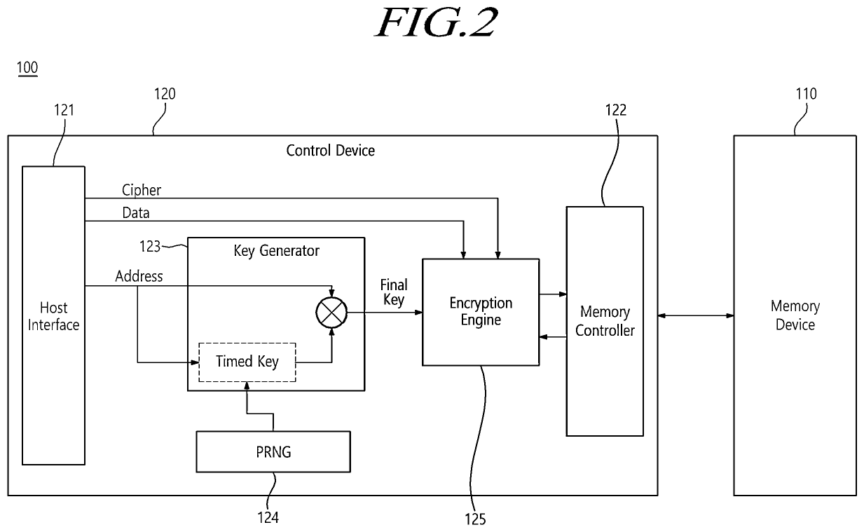

FIG. 2 is a diagram illustrating a configuration of a data storage system according to an embodiment of the disclosure.

Referring to FIG. 2, a memory device 110 included in a data storage system 100 is illustrated as an example. The memory device 110 may include a plurality of memory cells that store data. The memory device 110 may include a word line and a bit line for driving each of the plurality of memory cells. The memory device 110 may include various circuits that control writing and reading of data to and from the memory cell while driving the word line and the bit line.

The control device 120 that controls the memory device 110 may include, for example, a host interface 121 that communicates with a host device 200.

The host interface 121 may transmit and receive data to and from the host device 200, and may provide a command and data received from the host device 200 to other elements in the control device 120.

The control device 120 may include a memory controller 122. The memory controller 122 may communicate with the memory device 110 and control the operation of the memory device 110.

The memory controller 122 may be included within a control device 120 as illustrated in FIG. 2, or may be located outside the control device 120. The memory controller 122 and the memory device 110 may be implemented in the form of a single chip or package.

The control device 120 may include a key generator 123 that generates a key for encryption and decryption. The control device 120 may include a random number generator PRNG 124 that provides a random number to the key generator 123. The control device 120 may include an encryption engine 125 that encrypts or decrypts data using the key.

All components included in the control device 120 may be configured as a single chip. In some embodiments, components included in the control device 120 may be implemented in the form of a plurality of chiplets. A plurality of chiplets that perform some functions of the control device 120 may be packaged to configure the control device 120.

The control device 120 may encrypt data to be written to the memory device 110 or decrypt data written to the memory device 110, using the encryption engine 125.

The encryption engine 125 may perform encryption or decryption using a key provided by the key generator 123. The encryption engine 125 may encrypt data according to an encryption command received from the host device 200.

The key generator 123 may generate a timed key that changes at various times. The timed key may also be regarded as a key whose validity is maintained for a certain period of time, and may also be referred to as a time-limited key.

The key generator 123 may receive a random number from the random number generator PRNG 124 at a preset time. The key generator 123 may generate a timed key using the random number.

The key generator 123 may generate a final key (or an actual key) using the timed key. The key generator 123 may provide the final key to the encryption engine 125. The encryption engine 125 may perform encryption and decryption on data using the final key.

For example, the key generator 123 may provide the generated timed key as the final key to the encryption engine 125.

Alternatively, the key generator 123 may generate a final key using the timed key and at least a part of information received from the outside, and then output the final key to the encryption engine 125.

For example, the key generator 123 may generate a final key on the basis of a timed key and an address received from the host device 200. The final key may change after a period of time elapses, and also the final key may change according to an address corresponding to a command.

Since the encryption engine 125 performs encryption using the timed key, which changes from time to time, an encryption algorithm used by the encryption engine 125 may be simply configured.

For example, the encryption engine 125 may use an encryption method in which an algorithm, according to the Advanced Encryption Standard (AES), the Data Encryption Standard (DES), etc. as non-limiting examples, is performed only once.

Alternatively, the encryption engine 125 may use an encryption method that is a scrambler method based on a linear feedback shift register (LFSR).

An encryption method used by the encryption engine 125 is not limited to the examples described above, and may be a method using any one of various algorithms that use a timed key and is capable of providing the same or a similar level of security as when a fixed key is used. In addition, an encryption method may be a method that uses an algorithm specified by the provider of the data storage system 100, the memory device 110 or the control device 120.

According to embodiments of the disclosure, since encryption is performed using a timed key that changes over time, it is possible to decrease the complexity of an encryption algorithm used by the encryption engine 125 and to maintain security using encryption. By decreasing the complexity of the encryption algorithm, an increase in the size of the control device 120, which provides the encryption function, may be minimized.

The key generator 123 of the control device 120 may generate and provide a final key by using a separate key in addition to the timed key.

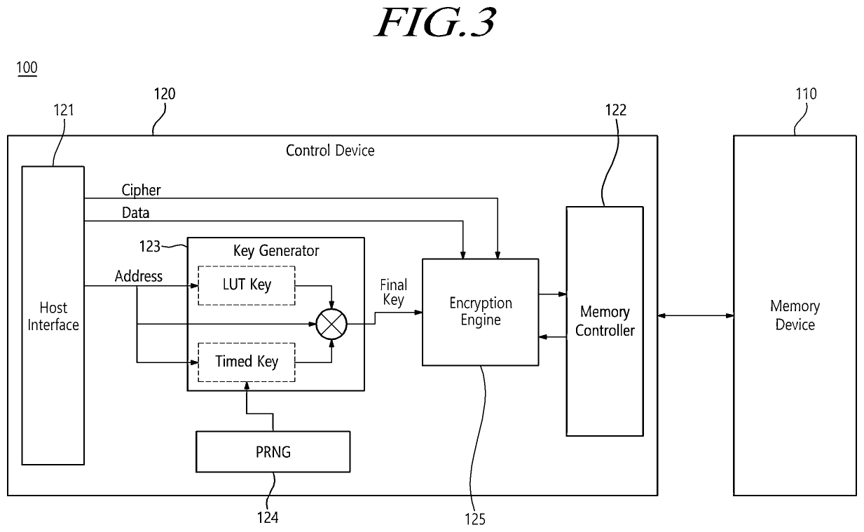

FIG. 3 is a diagram illustrating another configuration of a data storage system according to an embodiment of the disclosure.

Referring to FIG. 3, a data storage system 100 may include a memory device 110 and a control device 120.

A key generator 123 included in the control device 120 may generate a timed key and a fixed key (or a lookup table key LUT Key). The fixed key may be a key that is determined using at least one fixed value. For example, a plurality of key values may be stored in a lookup table. One of the key values stored in the lookup table may be selected as the fixed key.

For example, the fixed key may be selected on the basis of information inputted from the outside. The fixed key may be selected on the basis of an address according to a command inputted from a host device 200.

The key generator 123 may generate a timed key by receiving a random number from a random number generator PRNG 124 at a preset time. The key generator 123 may generate the fixed key on the basis of a key value stored in the lookup table. The key generator 123 may generate a final key on the basis of the timed key and the fixed key and may provide the final key to an encryption engine 125.

Since the final key generated using the fixed key and the timed key, which changes depending on the time the timed key is generated, it is possible to decrease the complexity of an encryption algorithm by the encryption engine 125 and to maintain the security of encrypted data.

As such, embodiments of the disclosure may provide a final key used for encryption and decryption, by generating the final key using a timed key that changes depending on time or by using both a timed key and a fixed key.

Since encryption is performed using a timed key, an area and power for encryption may be reduced and encryption performance may be improved.

A timed key may be generated and provided in accordance with a preset timing. Alternatively, a timed key may be generated and provided on the basis of at least one of operation periods of the memory device 110.

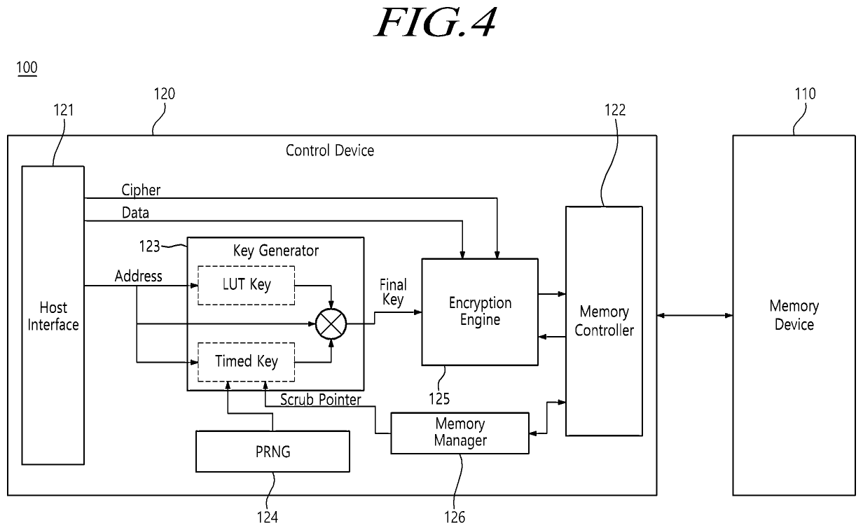

FIG. 4 is a diagram illustrating a further configuration of a data storage system according to an embodiment of the disclosure.

Referring to FIG. 4, a data storage system 100 may include a memory device 110 and a control device 120. The control device 120 may include a host interface 121, a memory controller 122, a key generator 123, a random number generator PRNG 124, and an encryption engine 125. The control device 120 may include a memory manager 126.

The memory manager 126 may manage the state of the memory device 110 or at least one operation associated with the memory device 110. The memory manager 126 may be disposed separately from the memory controller 122 or may be integrated with the memory controller 122.

The memory manager 126 may manage the period of an operation for preserving data stored in the memory device 110. For example, the memory manager 126 may manage the time periods between patrol scrub operations of the memory device 110. The memory manager 126 may manage the time intervals for refresh operations of the memory device 110.

When the memory device 110 is a nonvolatile memory, the memory manager 126 may also manage the timing of operations of writing and erasing data to and from a storage block included in the memory device 110.

The memory manager 126 may provide information on the timing of at least one operation associated with the memory device 110 to the key generator 123.

The key generator 123 may control the timing of generating a timed key on the basis of the period of the operation associated with the memory device 110, which is received from the memory manager 126.

For example, the memory manager 126 may provide, to the key generator 123, information on the period of a patrol scrub operation (hereinafter also referred to as a “scrub operation”), which entirely rewrites data stored in the memory device 110 at regular intervals or periods.

The key generator 123 may generate a timed key on the basis of the length of the period (e.g., 6 h, 12 h, 24 h, etc.) between scrub operations.

For example, the key generator 123 may generate a timed key in accordance with the period of the scrub operation. The key generator 123 may generate one timed key when the period of the scrub operation starts. The key generator 123 may generate a new timed key when the next period of the scrub operation starts. Since the key generator 123 generates and provides a timed key in accordance with the beginning of each period of the scrub operations, the encryption engine 125 may encrypt or decrypt data using a final key based on a periodically changing timed key.

The key generator 123 may generate and provide the final key using the timed key, as in the example described above. The key generator 123 may generate and provide a final key using a timed key and a fixed key. The key generator 123 may generate a final key using at least a part of information received from the outside. For example, the key generator 123 may generate a final key using an address corresponding to a command from the host device 200.

For example, one of a plurality of fixed values stored in a lookup table may be selected based on the address. A timed key may be generated used the address as an input value in a logic that generates a timed key. A final key may be generated on the basis of a timed key, a fixed key and an address and may be provided to the encryption engine 125.

Since the key generator 123 provides a final key based on a timed key to the encryption engine 125, encryption performance may be improved. In addition, since a timed key is generated on the basis of the period of an operation associated with the memory device 110, management of an encryption or decryption operation based on the timed key may be facilitated.

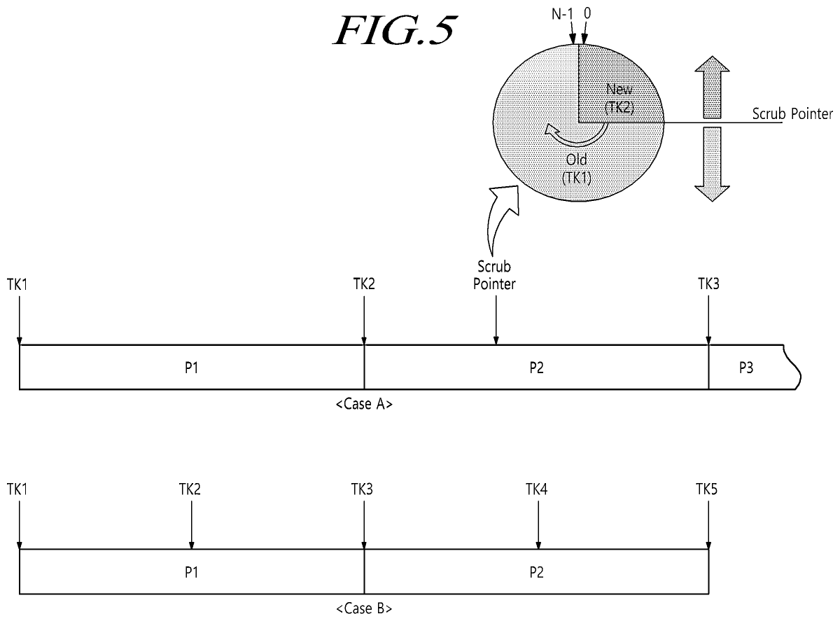

FIG. 5 is a diagram illustrating a key generation method by a data storage system according to an embodiment of the disclosure.

FIG. 5 illustrates methods in which a key generator 123 generates a timed key on the basis of the period of a scrub operation of a memory device 110.

Referring to <Case A>, the key generator 123 may generate a timed key in accordance with the period of the scrub operation of the memory device 110. The key generator 123 may generate a timed key TK1 in accordance with the start of a first period P1 of the scrub operation. The key generator 123 may generate a timed key TK2 in accordance with the start of a second period P2 of the next scrub operation.

The progress of the scrub operation of the memory device 110 may be checked by a scrub pointer. The scrub pointer may represent information indicating an address of a memory area at which the scrub operation has progressed in the memory device 110. When there are an N number of addresses indicating memory areas, the scrub pointer may indicate one of 0 to N−1.

The scrub pointer indicates that the scrub operation has been completed for memory areas up to an address indicated by the scrub pointer, and that the scrub operation on memory areas after the address has not yet occurred.

Since the progress of the scrub operation is determined by the scrub pointer, other timed keys may be applied to memory areas that can be distinguished on the basis of the scrub pointer. In the present disclosure, the use of a timed key may mean that encryption or decryption is performed using the timed key directly or with a final key generated using the timed key.

For example, data encryption or decryption based on the timed key TK1 may be performed during the first period P1 of the scrub operation. When the second period P2 of the next scrub operation starts, data written to memory areas of the memory device 110 may be data encrypted by the timed key TK1, which is a previous (or old) timed key.

When the second period P2 of the scrub operation starts, the timed key TK2 may be generated. The scrub operation may be performed by the next (or new) timed key TK2.

For example, the control device 120 may decrypt data already written to memory areas up to an address indicated by the scrub pointer in the memory device 110, by using the timed key TK1. When there is an error in the decrypted data, the control device 120 may correct the error. The control device 120 may encrypt the decrypted data using the timed key TK2. The control device 120 may rewrite the data encrypted using the timed key TK2 to the memory areas where the corresponding data is originally written.

Encryption and decryption using the new timed key TK2 may be performed on memory areas where the scrub operation by the control device 120 has occurred. Encryption and decryption using the previous timed key TK1 may be performed on memory areas where the scrub operation by the control device 120 has not progressed. In the present disclosure, a memory area before the scrub operation progresses may be referred to as a first memory area, and a memory area in which the scrub operation has progressed may be referred to as a second memory area.

When a third period P3 of the scrub operation starts, similarly, another timed key TK3 may be generated. The timed keys TK2 and TK3 may be used during a period of time corresponding to the third period P3. During the period of time corresponding to the third period P3, the timed key TK2 may be used for data of memory areas in which the scrub operation has not progressed, and the timed key TK3 may be used for data of memory areas in which the scrub operation has progressed. During the period of time corresponding to the third period P3, the timed key TK1 may be discarded.

Since the generation of a timed key is performed in accordance with the period of the scrub operation of the memory device 110, a timed key used for data written to each memory area may be easily checked on the basis of the scrub pointer. Management of data encrypted on the basis of a timed key, which changes depending on a time may be facilitated.

A timed key may be generated in accordance with the period of the scrub operation of the memory device 110 as in Case A described above, or may be generated in accordance with a new period set on the basis of the period of the scrub operation.

For example, a timed key may be generated in each period of time corresponding to 1/M (where M is an integer satisfying M≥1) of the period of the scrub operation.

Referring to <Case B>, a timed key may be generated in each period of time corresponding to ½ of the period of the scrub operation. Two timed keys may be generated during a period of time corresponding to the period of the scrub operation. Timed keys TK1 and

TK2 may be generated during a first period P1 of the scrub operation, and timed keys TK3 and TK4 may be generated during a second period P2 of the scrub operation.

During a period of time corresponding to the second period P2 of the scrub operation, depending on a memory area, the timed keys TK1 and TK2 generated during the first period P1 may be used or the timed keys TK3 and TK4 generated during the second period P2 may be used.

Since the control device 120 generates a timed key for encryption of data stored in the memory device 110 on the basis of the period of an operation of the memory device 110, encryption performance using the timed key may be improved, and even when the timed key changes, the data encrypted using the timed key may be easily managed.

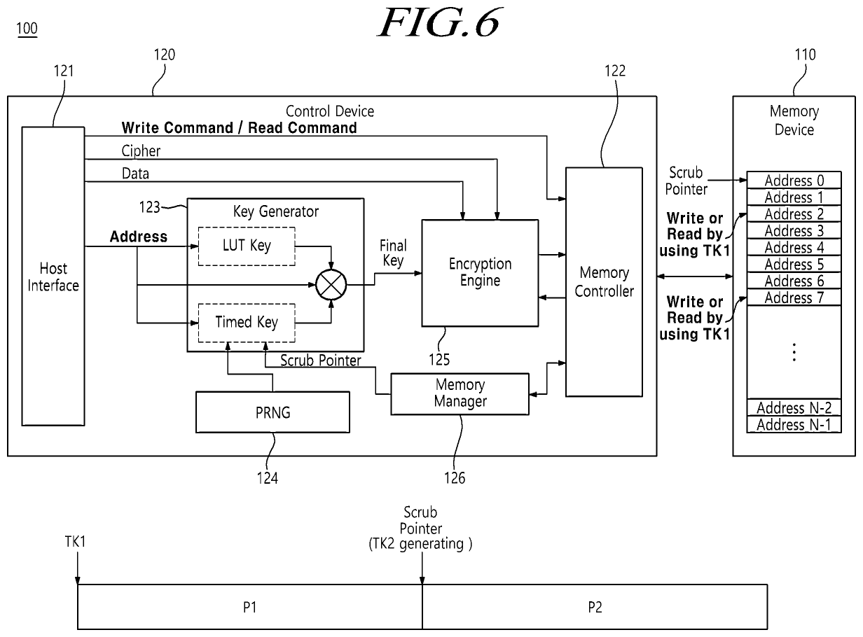

FIGS. 6 to 8 are diagrams illustrating methods in which a data storage system processes data using a key according to an embodiment of the disclosure.

Referring to FIG. 6, a control device 120 of a data storage system 100 generates a timed key in accordance with the period of a scrub operation of a memory device 110. In FIG. 6, a command is processed when a second period P2 of the scrub operation starts.

A memory manager 126 of the control device 120 may provide period information according to the scrub operation of the memory device 110 to a key generator 123. The key generator 123 may receive a random number from a random number generator PRNG 124 and generate a timed key TK1, in accordance with a first period P1 of the scrub operation. The key generator 123 may receive a random number from the random number generator PRNG 124 and generate a timed key TK2, in accordance with the second period P2 of the scrub operation.

When the number of addresses of the memory areas included in the memory device 110 is N, the scrub pointer may indicate an address 0 when the second period P2 of the scrub operation starts. Alternatively, the scrub pointer may indicate an address N−1 corresponding to a last memory area on which the scrub operation has been completed during a period of time corresponding to the first period P1.

Since the scrub pointer indicates an address 0 or an address N−1, the scrub operation has not progressed during a period of time corresponding to the second period P2.

Data already written to the memory areas of the memory device 110 may have been written by being encrypted using the timed key TK1 during the first period P1 of the scrub operation.

A write command or a read command may be received from a host device 200 during the period of time corresponding to the second period P2 of the scrub operation. Since the scrub operation has not yet progressed during the period of time corresponding to the second period P2 of the scrub operation, the control device 120 may process the command using the previously used timed key TK1.

For example, when writing or reading data to or from a memory area indicated by an address 2, the control device 120 may perform encryption or decryption using the timed key TK1. When writing or reading data to or from a memory area indicated by an address 7, the control device 120 may perform encryption or decryption using the timed key TK1.

The control device 120 may perform data processing according to a command from the host device 200, by applying a previous timed key or a new timed key to a memory area distinguished on the basis of the scrub pointer, which changes position as the scrub operation progresses.

When the scrub operation progresses, the control device 120 may perform the scrub operation using a timed key generated in accordance with the period of the corresponding scrub operation. As the scrub operation progresses, the address of a memory area indicated by the scrub pointer may change. A timed key used for a corresponding memory area may be changed on the basis of the scrub pointer.

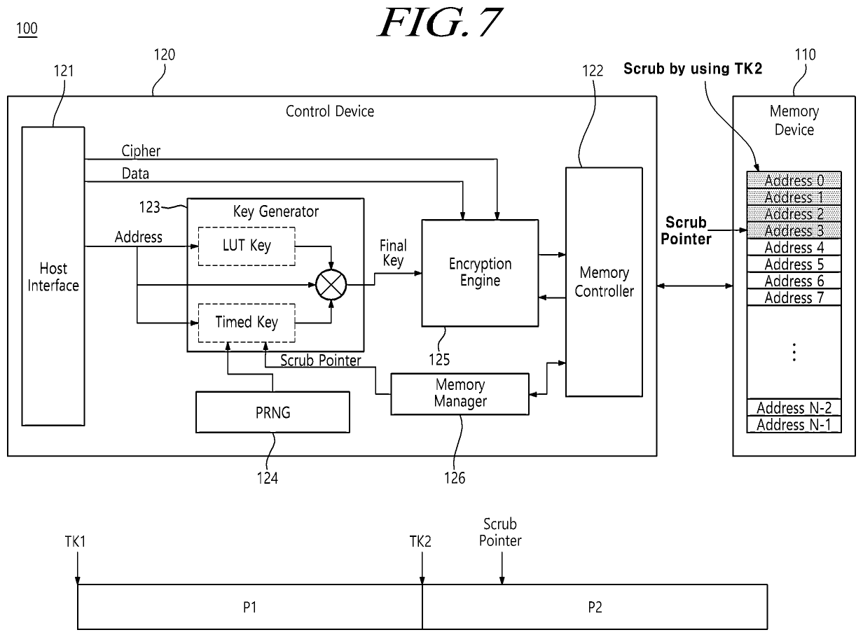

For example, referring to FIG. 7, the timed key TK2 may be generated in accordance with the second period P2 of the scrub operation of the memory device 110. The key generator 123 may generate a final key based on the timed key TK2 and a fixed key, and may provide the final key to an encryption engine 125. The encryption engine 125 may encrypt or decrypt data using the final key based on the timed key TK2.

The scrub operation on memory areas may be performed during the period of time corresponding to the second period P2 of the scrub operation of the memory device 110.

The control device 120 may perform the scrub operation sequentially from a memory area indicated by the address 0, from among the memory areas included in the memory device 110. The scrub operation may be performed by a memory controller 122 or a memory manager 126. While the scrub operation is in progress, decryption and encryption of data stored in a corresponding memory area may be performed by the encryption engine 125.

When performing the scrub operation, the encryption engine 125 may decrypt data using the previous timed key TK1 and encrypt data to be stored again using the new timed key TK2.

The scrub operation may be performed by the control device 120 starting from the memory area indicated by the address 0. As the scrub operation progresses, an address indicated by the scrub pointer may change. FIG. 7 illustrates a scrub operation that has progressed up to a memory area indicated by an address 3 during the period of time corresponding to the second period P2 of the scrub operation.

When the scrub pointer indicates the address 3, the scrub operation for memory areas indicated from an address 4 to the address N−1, from among the memory areas of the memory device 110, may have been performed using the previous timed key TK1. The scrub operation for memory areas indicated by the address 0 to the address 3 may have been performed using the new timed key TK2.

In this way, when a command is received from the host device 200 while the scrub operation is in progress, encryption or decryption may be performed by applying different timed keys to memory areas that are distinguished on the basis of the scrub pointer.

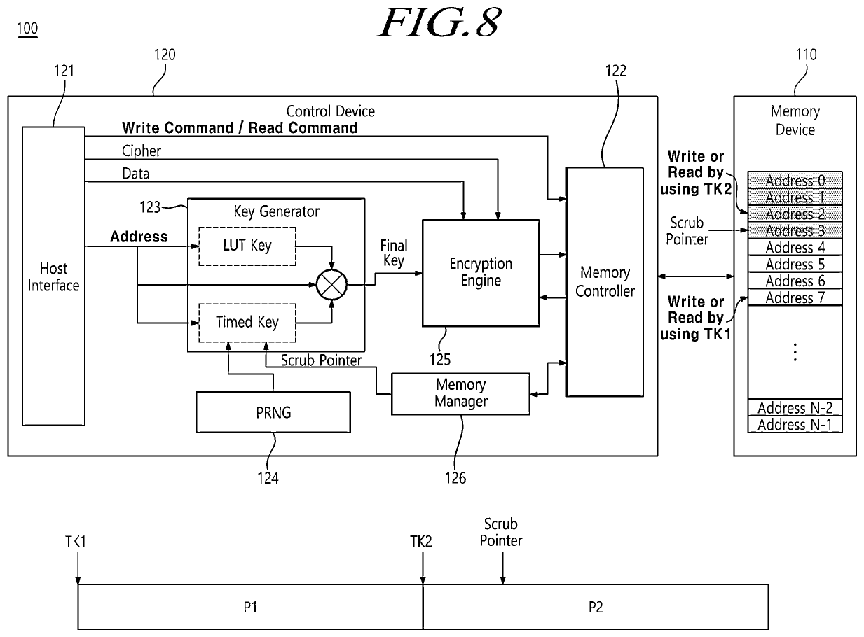

For example, FIG. 8 illustrates a write command or a read command that is received from the host device 200 during the period of time corresponding to the second period P2 of the scrub operation of the memory device 110 is illustrated.

When receiving the write command or the read command from the host device 200, the control device 120 may check an address according to the command. The control device 120 may determine a timed key to be used in encryption or decryption of data, on the basis of the address according to the command.

For example, when the address according to the command indicates a memory area in which the scrub operation has not yet been performed during the period of time corresponding to the second period P2 of the scrub operation, the control device 120 may process the command using the previous timed key TK1.

When the address according to the command is an address 7, the control device 120 may encrypt data using the previous timed key TK1 and write the encrypted data to the memory area indicated by the address 7. The control device 120 may decrypt data written to the memory area indicated by the address 7 using the previous timed key TK1 and provide the decrypted data to the host device 200.

In another example, when the address according to the command indicates a memory area in which the scrub operation has progressed during the period of time corresponding to the second period P2 of the scrub operation, the control device 120 may process the command using the new timed key TK2.

When the address according to the command is an address 2, the control device 120 may encrypt data using the new timed key TK2 and write the encrypted data to the memory area indicated by the address 2. The control device 120 may decrypt data written to the memory area indicated by the address 2 using the new timed key TK2 and provide the decrypted data to the host device 200.

Since encryption and decryption of data are performed using a timed key, which is generated in accordance with the period of the scrub operation, even if a key that changes depending on time is used, data processing according to a command from the host device 200 may be facilitated.

Furthermore, in embodiments of the disclosure, a timed key may be generated and managed on the basis of at least one of the periods of various operations performed in association with the memory device 110 in addition to the scrub operation.

The periods of the operations performed in association with the memory device 110 may mean the period of any one operation from among all operations of sequentially writing data to the memory areas of the memory device 110. For example, in addition to the period of the scrub operation described above, a period of time corresponding to a multiple of the period of a refresh operation or a period in which writing and erasing of data on a storage block of a nonvolatile memory is performed may be used to generate a timed key.

According to embodiments of the disclosure, by performing encryption and decryption of data stored in the memory device 110 using a timed key that changes depending on a time, it is possible to decrease the complexity of an encryption algorithm and improve encryption performance. Data encryption performance may be improved while reducing the size and power of the control device 120 according to encryption.

Moreover, by controlling the period of generating a timed key in accordance with the period of an operation associated with the memory device 110, generation and management of the timed key may be facilitated. Through encryption using a timed key, encryption performance may be improved, and the complexity of managing encrypted data may be decreased.

The embodiments of the present disclosure described above will be briefly described as follows.

A data storage system according to the embodiments of the present disclosure may include a memory device, and a control device configured to control an operation of the memory device, generate at least one timed key on the basis of a period of a scrub operation of the memory device, and perform, by using the at least one timed key, encryption on data to be written to the memory device or decryption on data written to the memory device.

A control device according to the embodiments of the present disclosure may include a random number generator configured to provide a random number for a period of a scrub operation of a memory device, a key generator configured to generate at least one timed key on the basis of the random number, and an encryption engine configured to encrypt data to be written to the memory device using the at least one timed key.

A memory device according to the embodiments of the present disclosure may include a memory cell array including a plurality of memory cells, and a memory controller configured to control an operation of the memory cell array, generate at least one timed key on the basis of a period of a scrub operation for the memory cell array, and perform, using the at least one timed key, encryption or decryption on data to be written to the memory cell array.

A data storage system according to embodiments of the present disclosure may include a memory device, and a control device configured to control an operation of the memory device, to generate a final key on the basis of a fixed key according to at least one fixed value and a timed key according to a value that changes depending on a time, and using the final key, to encrypt data to be written to the memory device or decrypt data written to the memory device.

In the data storage system, the control device may generate the final key using the timed key, which is generated for a period of performing an operation of rewriting data already written to the memory device.

Although various embodiments of the disclosed technology have been described with particular specifics and varying details for illustrative purposes, those skilled in the art will appreciate that various modifications, additions and substitutions may be made based on what is disclosed or illustrated in the disclosed technology without departing from the spirit and scope of the disclosed technology as defined in the following claims.

What is claimed is:

1. A data storage system comprising:
a memory device; and
a control device configured to control an operation of the memory device, generate at least one timed key on the basis of a period of a scrub operation of the memory device, and perform, by using the at least one timed key, encryption on data to be written to the memory device or decryption on data written to the memory device.

2. The data storage system according to claim 1, wherein the control device generates a first timed key in a first period of the scrub operation, generates a second timed key in a second period of the scrub operation, and performs the encryption and the decryption using the first timed key and the second timed key during a period of time corresponding to the second period.

3. The data storage system according to claim 2, wherein the control device selects the first timed key or the second timed key on using an address according to a command received from an outside, and processes the command using a selected timed key.

4. The data storage system according to claim 2, wherein
during a period of time corresponding to the second period, the control device writes data encrypted using the first timed key to a first memory area of the memory device and writes data encrypted using the second timed key to a second memory area of the memory device, and
the first memory area and the second memory area are distinguished by a scrub pointer indicating an address at which the scrub operation has progressed.

5. The data storage system according to claim 4, wherein during a period of time corresponding to the second period, the control device decrypts data written to the first memory area using the first timed key and decrypts data written to the second memory area using the second timed key.

6. The data storage system according to claim 4, wherein as an operation time increases in a period of time corresponding to the second period, the second memory area increases and the first memory area decreases.

7. The data storage system according to claim 2, wherein the control device performs the scrub operation using the second timed key during a period of time corresponding to the second period.

8. The data storage system according to claim 2, wherein during a period of time corresponding to the second period, the control device decrypts data already written to the memory device using the first timed key, and by encrypting the data using the second timed key, writes the encrypted data to the memory device.

9. The data storage system according to claim 2, wherein the control device generates a third timed key in a third period of the scrub operation of the memory device, and during the third period, maintains the second timed key and the third timed key and discards the first timed key.

10. The data storage system according to claim 9, wherein, during the third period, the control device performs the encryption or the decryption using the second timed key on data of a memory cell on which the scrub operation has not been performed and performs the encryption or the decryption using the third timed key on data of a memory cell on which the scrub operation has been performed.

11. The data storage system according to claim 1, wherein the control device performs the encryption and the decryption using a final key that is generated using a fixed key corresponding to a fixed value and at least one timed key.

12. The data storage system according to claim 1, wherein the control device generates the timed key in each period of time corresponding to 1/M (where M is an integer satisfying M≥1) of the period of the scrub operation of the memory device.

13. The data storage system according to claim 1, wherein the control device comprises a random number generator that provides a random number for the period of the scrub operation of the memory device.

14. The data storage system according to claim 13, wherein the control device comprises a key generator that generates the at least one timed key on the basis of the random number and an encryption engine that encrypts data to be written to the memory device using the at least one timed key.

15. A control device comprising:
a random number generator configured to provide a random number for a period of a scrub operation of a memory device;
a key generator configured to generate at least one timed key on the basis of the random number; and
an encryption engine configured to encrypt data to be written to the memory device using the at least one timed key.

16. The control device according to claim 15, wherein the key generator generates and provides a final key using a fixed key corresponding to at least one fixed value and at least one timed key.

17. The control device according to claim 16, wherein
the key generator generates the final key on the basis of a first timed key when an address according to a command received from an outside is a first address, and generates the final key on the basis of a second timed key when the address is a second address, and
the first address and the second address are distinguished by a scrub pointer indicating an address at which the scrub operation has progressed.

18. A memory device comprising:
a memory cell array including a plurality of memory cells; and
a memory controller configured to control an operation of the memory cell array, generate at least one timed key on the basis of a period of a scrub operation for the memory cell array, and perform, using the at least one timed key, encryption or decryption on data to be written to the memory cell array.

19. The memory device according to claim 18, wherein during a period of time corresponding to the period of the scrub operation, the memory controller performs the encryption or the decryption using a first timed key on data of a memory cell on which the scrub operation has not been performed and performs the encryption or the decryption using a second timed key on data of a memory cell on which the scrub operation has been performed.

20. The memory device according to claim 19, wherein when the period of time corresponding to the scrub operation ends and a period of time corresponding to a new period starts, during the period of time corresponding to the new period, the memory controller performs the encryption or the decryption using the second timed key on data of a memory cell on which the scrub operation has not been performed and performs the encryption or the decryption using a third timed key on data of a memory cell on which the scrub operation has been performed.
